(19) United States
(12) Patent Application Publication
(10) Pub. No.: US 2012/0143706 A1
(43) Pub. Date: Jun. 7, 2012

(54) Method and System for Improved Electronic Wallet Access

(76) Inventors: David A. Crake, Newark, DE (US); Glenn Curtiss McMillen, Downingtown, PA (US); Garry R. Lloyd, Northampton (GB); Eric Crozier, Hockessin, DE (US)

(21) Appl. No.: 13/247,352

(22) Filed: Sep. 28, 2011

Related U.S. Application Data
(63) Continuation-in-part of application No. 12/905,419, filed on Oct. 15, 2010.

(51) Int. Cl. G06Q 20/32; G06Q 20/36

(52) U.S. Cl. 705/18

(57) ABSTRACT

A mobile payment method and system are described that facilitate efficient and secured payment transactions from an electronic wallet on a user mobile electronic device with a merchant point of sale terminal over a contactless communications link. In one aspect, the system provides for a plurality of passcode entry related states on the mobile electronic device. The mobile device transmits a transaction request message including a multi-faceted value identifying a passcode entry related state to a payment processing server. The payment processing server processes the transaction request and when the transaction request is declined for a passcode related reason, a transaction decline response is provided identifying the passcode related reason for decline.

### CROSS-REFERENCE TO RELATED APPLICATION

The present application is a continuation-in-part of U.S. Ser. No. 12/905,419, entitled “MOBILE PAYMENT SYSTEM” filed Oct. 15, 2010 ('419 application), which is currently pending, and which is incorporated herein in its entirety by reference.

### FIELD OF THE INVENTION

This invention relates to a mobile payment account system, and more particularly to an improved mobile payment application on a mobile device to enable more efficient and secured contactless payment at an electronic Point Of Sale.

### BACKGROUND OF THE INVENTION

Mobile payment account systems are generally known, in which portable electronic devices are configured to provide payment from an electronic wallet. Typically, these portable electronic devices are configured to enable a contactless communication with a merchant Point Of Sale (POS) terminal to carry out a payment transaction, using near field communication (NFC) technology. As described in the above-referenced '419 application, activated mobile payment account data can be stored in the secure element of the portable electronic device which can then be used to carry out transactions with the merchant electronic POS terminal via a NFC link.

Systems described in the above-referenced '866 application and '419 application advantageously provide the customer with the ability to apply for a payment product that, once approved, is immediately provisioned and activated on the mobile device, thus allowing the customer to immediately make purchases using the activated mobile payment account. As described in the '866 application, provisioning of a mobile payment account, in response to an instant provisioning request from the mobile device, involves creation and communication of data for the mobile payment account to the mobile device. Activation of the mobile payment account provisioned on the mobile device typically involves authentication of the user before the mobile payment account is enabled for use in the mobile payment system.

However, conventional mobile payment systems typically involve a complicated process in order for a user to effect a secured payment transaction from an electronic wallet. For example, U.S. Pat. No. 7,707,113 to Sprint Communications Company L.P. discusses a method of a portable electronic device providing payment from an electronic wallet with different levels of security. In a first level of security, the method prompts for input of a personal identification number (PIN) after the wallet has been opened and providing payment from the wallet after receiving the PIN. However, in another level of security, no PIN is required thus enabling efficient but unsecured payment transactions to be made from the electronic wallet.

Additionally, when customers use such a payment product to conduct low dollar transactions over contactless interfaces, a signature may not be required at the point of sale, nor a challenge for a numeric passcode (PIN) or a password. In the United States customers are able to wave their payment device and authorize the payment transaction without further interaction. For any theft of payment devices, the liability for these low dollar swipe transactions is placed upon the issuing bank, not the customer and not the merchant.

For payment accounts residing on mobile devices such as contactless payment capable mobile phones, the theft of a phone now becomes immediately available for low dollar purchases without consumer verification prior to a purchase. The perpetrator can make as many low dollar transactions without being challenged for authentication and access the payment account. All of these low dollar transactions will be the responsibility of the issuing bank under current payment association dispute rules. Customers may elect to always require a numeric passcode challenge for a purchase transaction regardless of the value, but this is not required.

What is desired is a more efficient mobile payment system and method which facilitates expedient and secured payment transactions from an electronic wallet, and improved prevention of fraudulent use of the electronic wallet.

In one aspect of the present invention, a method is provided for facilitating secured payment from an electronic wallet on a mobile device. The method is achieved by storing an electronic wallet comprising data for authorizing a payment transaction, wherein the data includes a passcode for enabling access to the electronic wallet. The method also includes generating a transaction request message including a value identifying one of a plurality of passcode entry related states and transmitting the generated transaction request message to a remote apparatus.

The remote apparatus can determine that the transaction request is declined based at least on the received value identifying a passcode entry related state. Responsive to determining that the transaction request is declined for a passcode related reason, the remote apparatus transmits a transaction decline response to the mobile device identifying the passcode related reason for decline.

In another aspect of the present invention, there is provided a mobile device adapted to perform the above method.

In yet a further aspect, there is provided a computer program comprising computer-implementable instructions for performing the above method when executed by a mobile device.

### BRIEF DESCRIPTION OF THE DRAWINGS

There now follows, by way of example only, a detailed description of embodiments of the present invention, with references to the figures identified below:

FIG. 1 is a block diagram showing the main components of a mobile payment system according to an embodiment of the invention;

FIG. 2a is a block diagram showing the main hardware and/or software elements of a mobile device shown in FIG. 1 according to an embodiment;

FIG. 2b is a block diagram showing the main functional elements of the mobile device shown in FIG. 2a according to embodiments of the invention;

FIG. 3 is a flow diagram illustrating the main processing steps performed by the mobile device of FIGS. 1 and 2 in a mobile payment process according to an embodiment;

FIG. 4, which comprises FIGS. 4a to 4d, is a flow diagram illustrating the main processing steps performed by the main components of the mobile payment system of FIG. 1 in the step of processing user inputs to activate a payment feature on the mobile device as illustrated in FIG. 3;

FIG. 5, which comprises FIGS. 5a to 5f, illustrates a sequence of screens displayed by the mobile device to the user during a mobile payment process according to embodiments of the present invention; and

FIG. 6, which comprises FIGS. 6a to 6d, illustrates a sequence of screens displayed by the mobile device to the user during a process for setting a default mobile payment account on the mobile device.

### DETAILED DESCRIPTION OF THE INVENTION

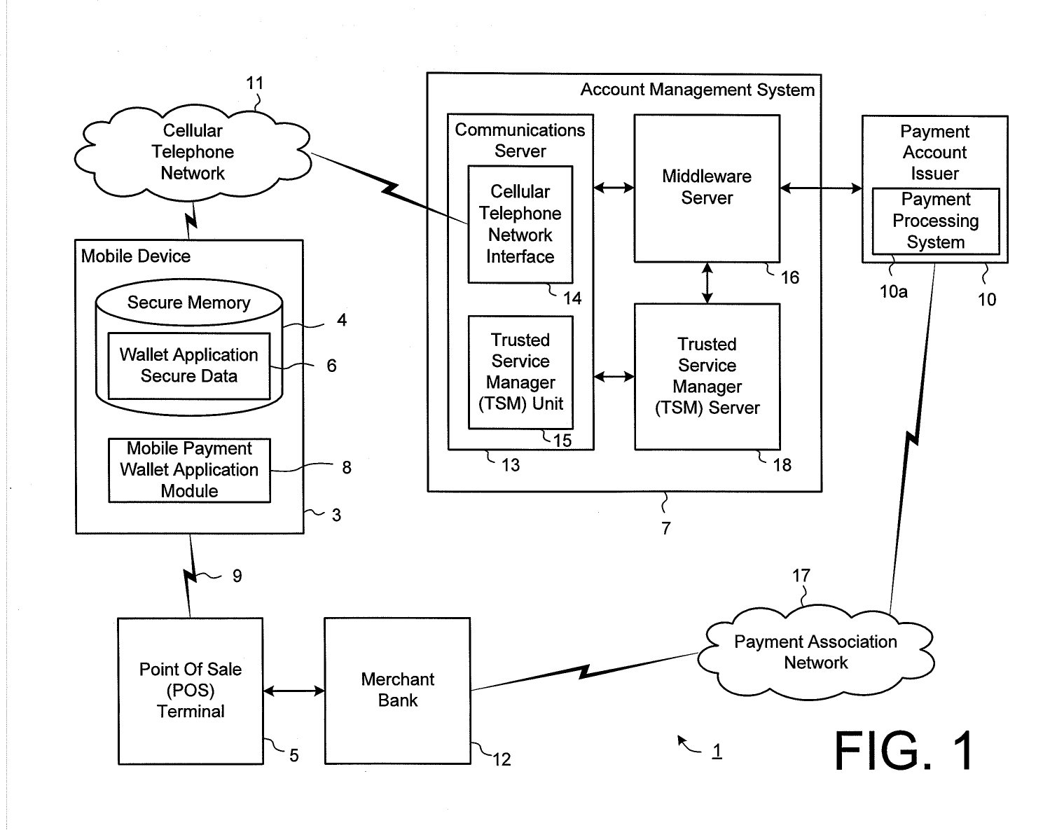

A specific embodiment of the invention will now be described for a process for requesting a payment transaction using a mobile device at a merchant's electronic point of sale terminal. Referring to FIG. 1, a mobile payment system 1 according to an embodiment comprises a mobile device 3, a merchant's electronic Point Of Sale (POS) terminal 5 as commonly known in the field, and an account management system 7 associated with a payment account issuer 10. The mobile device 3, merchant's electronic POS terminal 5, and the account management system 7 associated with the payment account issuer 10 communicate electronically with one another. The account management system 7 provides for mobile payment account creation and activation, transaction authorization, and other related functionality, as described in the above-referenced '866 application and '419 application.

As will be described below in greater detail, the account management system 7 includes a communications server 13 and a Trusted Service Manager (TSM) server 18 for facilitating communication between the middleware server 16 and the mobile device 3. The payment account issuer 10 includes a payment processing (authorization and fraud monitoring) system 10a for authorizing and effecting payment transactions from payment accounts associated with the payment account issuer 10 in response to payment transaction instructions received via a payment association network 17.

In this embodiment, the mobile device 3 and the electronic POS terminal 5 communicate with one another over a contactless communication link 9 via respective contactless communication interfaces (not shown). It is appreciated this contactless communication link 9 can be a near field communication (NFC) link, an infra-red link, an ultra-sonic link, an optical link, a radio frequency (eg. RFID) link, a wireless link such as Bluetooth or Wi-Fi based on the IEEE 802.11 standards, or any other communication link that does not require direct physical contact. The mobile device 3 communicates with the account management system 7 over a cellular telephone network 11 via a cellular network interface (not shown).

As shown in FIG. 1, the mobile device 3, that is, an electronic wallet as the term is used herein, includes a secure element 4 storing electronic wallet application secure data 6 including payment account data for one or more mobile payment accounts that have been set up on the mobile device 3. The secure element 4 can be a Universal Integrated Circuit Card (UICC) secure element, any other secure memory configuration, such as an embedded secure element chip, or as part of a peripheral accessory device to the mobile device 3, such as a micro Secure Digital card—otherwise known as a micro SD card, as are known in the art. Other forms of mobile handset software and/or hardware can be implemented to provide built-in secure electronic wallet functionality for accessing the secure element 4, including encryption and decryption of the wallet application secure data 6, as necessary. The mobile device 3 is configured with built-in functionality providing access to the secure element 4 on the Subscriber Identity Module (SIM) card in the mobile device 3.

In accordance with a preferred embodiment as shown with reference to FIG. 1, payment account data for a mobile payment account that is securely stored as wallet application secure data 6 in the mobile device 3 includes data identifying a user's account at a payment account issuer 10 from which funds can be transferred to the merchant bank to complete a transaction via a payment association network 17. The payment account data can additionally include data defining an amount of pre-paid funds that have been transferred from the user's payment account issuer 10 to that mobile payment account. In this way, the electronic wallet can include a payment account linked to multiple funding sources, such as a pre-paid account, deposit account and/or credit account. As an alternative, the electronic wallet can include a plurality of mobile payment accounts, each linked to a respective funding source.

The mobile device 3 also includes a wallet application module 8 storing processing instructions. In accordance with a preferred embodiment of the present invention processing instructions are computer-implementable instructions. The processing instructions are used to control the operation of the mobile device 3, to facilitate the application for and management of one or more mobile payment accounts on the mobile device 3 and to handle the process of conducting a transaction with a merchant via the electronic POS terminal 5. The transaction with a merchant via the electronic POS terminal 5 is facilitated using a mobile payment account on the mobile device 3 to effectively transfer funds from the mobile payment account on the mobile device 3, or an associated payment account issuer 10, to the merchant.

The wallet application module 8 can be implemented as one or more software components of an operating system running on the mobile device 3 or implemented as one or more separate software applications installed on the mobile device 3. In this embodiment, the wallet application module 8 comprises an authentication application for validating a user to activate a provisioned mobile payment account, and a payment application for facilitating payment transactions using an activated mobile payment account. The software applications can be configured to run as background applications on the mobile device 3 that monitor receipt of messages or events and activate upon receipt of appropriate messages or events so as to carry out the above operations. The software applications can alternatively be launched by the user. Alternatively, the wallet application module 8 is stored in the secure element 4, and is loaded into a virtual machine of the mobile device 3 to provide the functionality of the present embodiment.

The account management system 7 in the mobile payment system 1 will now be described in more detail with reference to FIG. 1, which shows the elements of the account management system 7 used in embodiments of the present invention. As shown, the account management system 7 includes a communications server 13, a middleware server 16, and a Trusted Service Manager (TSM) server 18, which communicate electronically with one another. In this embodiment, the servers communicate with one another via secure network links, for example over a private Local Area Network (LAN), a VPN connection, or other dedicated secure connection. It is appreciated that, although the components of the account management system 7 in this embodiment are provided as separate servers, one or more of the servers could be provided as software and/or hardware modules in the same server.

As shown in FIG. 1, data can be communicated between the mobile device 3 and the middleware server 16 over the cellular telephone network 11 via a cellular telephone network interface 14 of the communications server 13. The TSM server 18 performs logical data preparation of the data to be communicated to the mobile device by forming appropriate commands to be written to the secure element 4 of the mobile device 3. The precise form of the data depends on the particular implementation of the secure element 4 of the mobile device 3 and/or the payment association scheme program for facilitating payment. The TSM server 18 can also perform encryption of the sensitive payment account information in the mobile payment account data. The TSM server 18 then passes the encrypted data to the mobile device 3 via the communications server 13 and the cellular telephone network 11.

In the exemplary embodiment shown in FIG. 1, the communications server 13 includes a separate TSM unit 15 for establishing a trusted communication channel with a mobile device 3 via the cellular telephone network 11, and for securely routing the data to the mobile device 3. In the above example, the TSM unit 15 in the communications server 13 would not access any of the sensitive portions of the encrypted data that are routed to the mobile device 3 via the cellular telephone network interface 14. It is appreciated that the functionality of the TSM unit 15 can be integrated with the cellular telephone network interface 14.

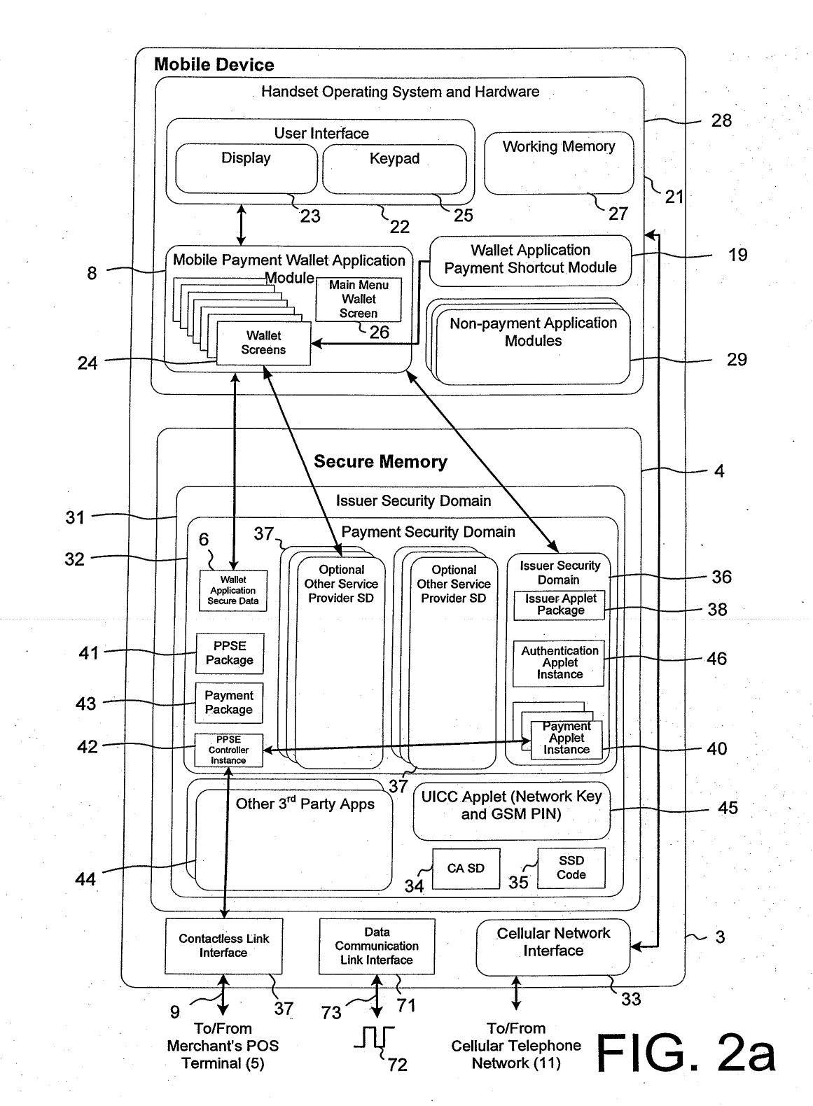

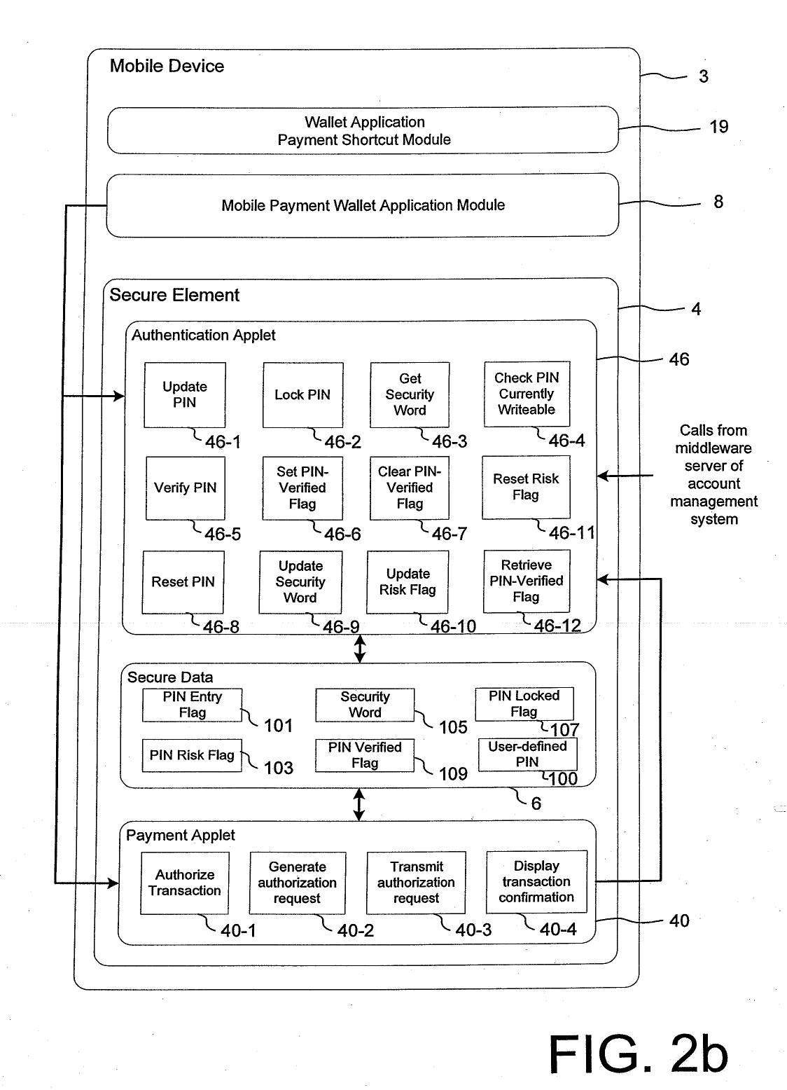

FIG. 2, which comprises FIGS. 2a and 2b, shows the elements of the mobile device 3 according to an embodiment of the present invention. In this embodiment, the mobile device 3 is a mobile handset. As shown in FIG. 2a, the mobile handset operating system and hardware includes a user interface 22 arranged to process inputs from a keypad 23 and to control output on a display 25. The keypad 23 and display 25 can be provided as separate hardware entities of the mobile device 3, or alternatively, as an integrated entity such as a touch sensitive display screen user interface. The mobile device 3 can also include components included in commonly known mobile handsets, such as a microphone, an earpiece speaker, a camera and a controller, and/or a GPS receiver etc., which are not shown. A working memory 27 is provided for use by the handset operating system and hardware units 21.

Software and data are transferred via the cellular network interface 33 or via a different data communication link interface 71 in the form of signals 72, which can be electronic, electromagnetic, optical, or other signals capable of being received by the data communication link interface 71 via a communication path 73 that carries the signals 72 and can be implemented using wire or cable, fiber optics, a physical phone line, a wireless link, a radio frequency link, or any other suitable communication channel, including any combination of suitable communication channels. The communication path 73 can be linked or merged with the communication path from the cellular network interface 33 to the cellular telephone network 11.

As mentioned above, the mobile device 3 includes a secure element 4. The mobile device 3 is operable to receive the wallet application secure data 6 and activation request messages from and send validation messages to the account management system 7 via the cellular telephone network interface 33 and the cellular telephone network 11. The mobile device 3 is also operable to store the received wallet application secure data 6 in the secure element 4. The mobile device 3 is also operable to receive transaction authorization request messages from and send authorization messages to the merchant's POS terminal 5 via the contactless communications link interface 39 and the contactless communication link 9. Communication between a POS terminal 5 and the mobile device 3 can involve transmission of data in a single direction from the mobile device 3 to the POS terminal 5, depending on an implemented protocol (such as the protocols used by the DISCOVER ZIP™, MasterCard PayPass™, Visa Paywave™ and AMEX ExpressPay™ cashless payment systems).

The mobile device 3 also includes a wallet application module 8 as mentioned above. The wallet application module 8 stores processing instructions used to control the operation of the mobile device 3 to perform various mobile payment account processes. Although not illustrated in FIG. 2a, the wallet application module 8 includes an account creation sub-module and an account activation sub-module. The account creation sub-module and the account activation sub-module store processing instructions to create a request for a new mobile payment account if desired and to carry out a secured account validation and activation processes in response to user input from the keypad 23 as described in the above-referenced '866 application. The wallet application module 8 also includes a transaction authorization sub-module which stores processing instructions used to control the operation of the mobile device 3 to carry out and authorize a transaction in response to user input from the user interface 22, as described in the above-referenced '419 application. The wallet application module 8 is configured to store a plurality of wallet screens 24 which can be output on the display 25 of the user interface 22 to facilitate user interaction with the sub-modules of the wallet application module 8. One wallet screen 26 is a main menu wallet screen displaying a list of user selectable options to access and manage payment account data of a selected mobile payment account stored on the mobile device 3. The mobile device 3 also stores one or more non-payment application modules 29 including processing instructions used to control the operation of the mobile device 3 to perform other non-payment related processes.

In this embodiment, the mobile device 3 further includes a payment shortcut module 19 that provides a shortcut to the payment feature within the mobile payment wallet application module 8. The shortcut can be implemented as processing instructions that link to the processing instructions of the transaction authorization sub-module. Alternatively, the payment shortcut module 19 can comprise separate processing instructions used to control the operation of the operating system and hardware units 21 to carry out and authorize a transaction in response to user input from the user interface 22. Provision of the payment shortcut module 19 advantageously enables an improved user interface for the transaction payment process that expedites the purchase process at a POS terminal 5 as the user avoids having to navigate through multiple wallet screens 24 of the mobile payment wallet application module 8 to authorize a payment transaction from the electronic wallet.

In an embodiment, the mobile payment wallet application module 8 facilitates user navigation from any one of the wallet screens 24 to the main menu wallet screen 26. It is appreciated that such navigation to the main menu wallet screen 26 can be direct or via one or more intermediary wallet screens 24. In this way, even though a user may have accessed the payment features of the mobile payment wallet application module 8 directly using the wallet application payment shortcut module 19 of the present invention, the user can navigate to any other wallet screen 24 of the mobile payment wallet application module 8.

Also schematically illustrated in the exemplary embodiment of FIG. 2a are security domains which can be implemented in the secure element 4 of the mobile device 3. The secure element 4 is advantageously implemented to be compliant with one or more specifications of a standard infrastructure in order to facilitate communication of data and messages between the mobile device 3 (and the secure element 4) and other entities in the mobile payment system 1. For example, and in accordance with a preferred embodiment, the secure element 4 is compliant with the known GlobalPlatform Card Specifications (for example the “GlobalPlatform Card Specification 2.2”, March 2006, which is incorporated herein by reference), and accordingly includes a plurality of security domains for facilitating control of the management of and accessibility to executable operations and sensitive data associated with specific areas of the secure element 4 by the various entities in the mobile payment system 1. The GlobalPlatform Card Specifications define a hierarchical arrangement of security domains, each defining functionality and data that can be accessed by a respective associated entity, for example, cryptographic keys or certificates, that can be used to support secure channel protocol operations between the mobile device 3 and the entity or entities associated with that particular security domain, and/or to authorize secure element 4 content management functions.

As shown in the exemplary embodiment of FIG. 2a, an issuer security domain 31 associated with a particular mobile network operator, includes a wallet security domain 32 associated with the payment account issuer 10, a Controlling Authority (CA) security domain 34 associated with a controlling authority in the mobile payment system 1, and a Supplementary Security Domain (SSD) code 35 associated with an intermediate security domain (not shown) to manage card content and perform cryptographic services for confidentiality. The wallet security domain 32 in this exemplary embodiment includes wallet application secure data 6a, which includes data for use by the wallet application module 8. The wallet security domain 32 also includes an issuer security domain 36 and one or more optional other service provider security domains 37. The issuer security domain 36 includes an issuer applet package 38, an authentication applet instance 46, and one or more payment applet instances 40 which enable the transaction processing functionality using an activated mobile payment account. The wallet application secure data 6 is also securely stored in the issuer security domain 36. The wallet security domain 32 also includes a Proximity Payment System Environment (PPSE) package or application 41, defining application functionality associated with transaction processing functionality and, in particular, for handling communications with a contactless reader of the POS terminal 5 to identify which of the one or more mobile payment accounts is to respond.

The wallet security domain 32 also includes a PPSE controller instance 42 for accessing the application functionality in the PPSE package 41 to facilitate an additional application layer level of control of the transaction processing functionality between the one or more payment applet instances 40 and the contactless communications link interface 39. In particular, the PPSE package 41 and PPSE controller instance 42 are advantageously provided where the mobile device 3 stores a plurality of mobile payment accounts and operates to communicate with the NFC reader of the merchant POS terminal 5 to control which one of the payment applet instances 40, associated with a respective mobile payment account stored on the mobile device 3, is to respond back to the POS reader.

Each security domain is associated with one or more respective entities in the mobile payment system 1 depending on the particular business model that is implemented by the mobile payment system 1. The specific implementation details of the various security domains for compliance with the GlobalPlatform Card Specifications are beyond the scope of this application and will be apparent to the skilled reader. The mobile device 3 also includes one or more other third party application modules 44 stored in the secure element 4, for example an application module related to a third party loyalty scheme. The secure element 4 also stores a UICC applet 45 which is an application to manage and hold the mobile network operator's functionality and secure information, such as a network key and GSM (Global Systems for Mobile Communications) PIN (Personal Identification Number).

FIG. 2b is a block diagram showing the main functional elements of the mobile device 3 when configured to execute processing instructions of the payment applet 40 and the authentication applet 46, according to an embodiment of the invention. As will be discussed in greater detail below, the mobile payment wallet application module 8 calls the payment applet instance 40 to conduct a payment transaction process, for example when a user waves the mobile device 3 past the contactless communication interface of the POS terminal 5. As shown in FIG. 2b, the payment applet 40 provides functional elements for authorizing a transaction 40-1, generating an authorization request 40-2, transmitting an authorization request 40-3 and displaying confirmation of a completed payment transaction 40-4. The payment applet 40 calls the authentication applet instance 46 to process, authorize and allow a payment transaction request to proceed. The authentication applet 46 tells the payment application if the PIN has been set and if it will allow the transaction request to proceed based upon various PIN entry flags. As shown in FIG. 2b, the authentication applet 46 also provides functional elements for updating the PIN 46-1, locking the PIN 46-2, obtaining a user defined security word 46-3 from the wallet application secure data 6, checking if the PIN is currently writeable 46-4, verifying the PIN 46-5, setting a PIN-verified flag 46-6, clearing a PIN-verified flag 46-7, resetting the PIN 46-8, updating the security word 46-9, updating the Risk flag 46-10, resetting the Risk flag 46-11 and retrieving the PIN-verified flag 46-12. Functional elements 46-1 to 46-7 and 46-11 are typically called by the mobile payment wallet application module 8, as will be described below. Functional elements 46-8 to 46-10 can be called by the account management system 7 from the middleware server 16 via the TSM server 18 in the form of Application Protocol Data Unit (APDU) commands to execute in the secure element 4 for remotely setting the PIN risk flag 103, as will be described below. Functional elements 46-12, as well as 46-7, are typically called by the payment applet 40.

The authentication applet 46 maintains a user-defined PIN 100, a PIN entry flag 101 for the state of PIN entry, a PIN risk flag 103, a security word 105, a PIN locked state 107 (from an issuer perspective) and a PIN-verified flag 109, which are stored securely as wallet application secure data 6 in the secure element 4 of the mobile device 3. In this embodiment, the PIN risk flag 103 is provided as an indication that an incorrect PIN was previously entered on the mobile device 3 and therefore advantageously facilitates prevention of fraud from the issuer perspective, because the customer can be forced to enter a PIN effectively by setting the PIN risk flag 103. The PIN risk flag 103 further allows for flexibility in not forcing a PIN for low dollar transactions while keeping control over the use of the mobile payment account. Transactions may be allowed to continue uninterrupted unless certain conditions arise requiring PIN verification. These conditions include, for example:
An authorization message providing an indication that incorrect PIN was previously entered and no correct PIN was provided for this transaction (for example with option 2 for dCVV); in such an instance, the middleware server 16 can choose to decline the payment transaction;
Built-in logic to prompt for PIN entry if a PIN was previously entered incorrectly or a configurable number of times without a PIN; and/or
Built in logic to detect remote set PIN entry required for a next transaction.

For example, when the PIN risk flag 103 is set to true, the authentication applet 46 initializes and/or calls the payment applet 40 to ask for PIN entry via a NFC push request. This condition would send an error to the payment applet 40 to not allow a transaction at this time. Upon successful PIN entry, the PIN risk flag is reset since the customer has successfully entered the PIN, thereby allowing the transaction to be made by the next wave and invocation of the payment applet 40. In effect, the PIN entry flag would be communicated from the authentication applet 46 to the payment applet 40 and through a payment authorization request to a merchant payment transaction authorization system via the electronic POS terminal 5, as is commonly known. The merchant's authorization system would then send the PIN entry information to a fraud/risk assessment unit (not shown) of the middleware server 16 to reset the PIN risk flag 103, as will be described in more detail below.

As an alternative, the processing instructions and functionality of the payment applet 40 and the authentication applet 46 may instead be provided as a single applet within the secure element 4. As yet another alternative, a plurality of applets may be included within the secure element 4 providing the functionality of embodiments of the present invention according to any desired bundling or collection of the respective processing instructions.

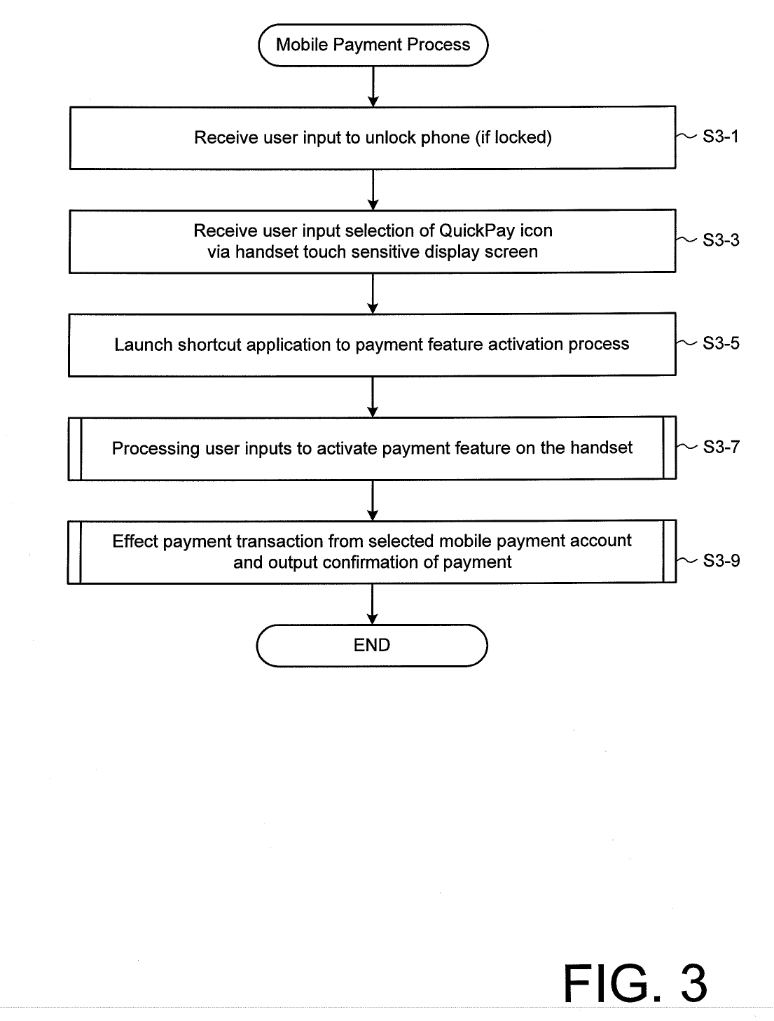

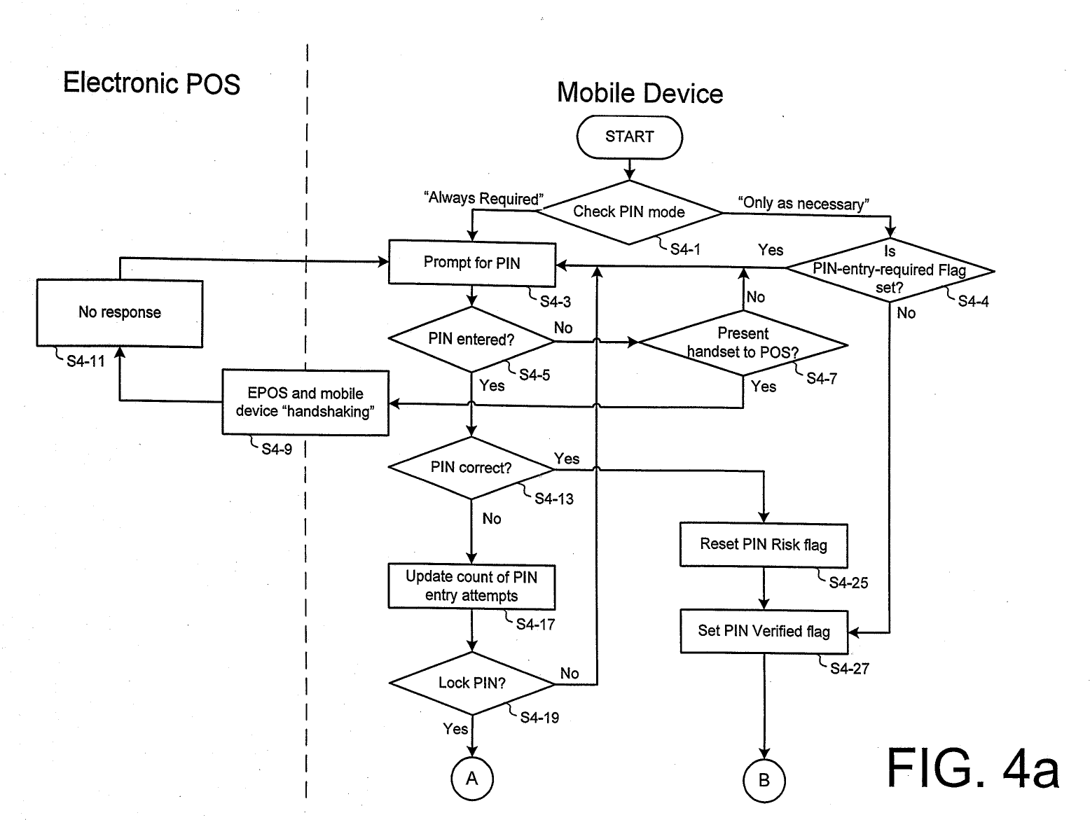

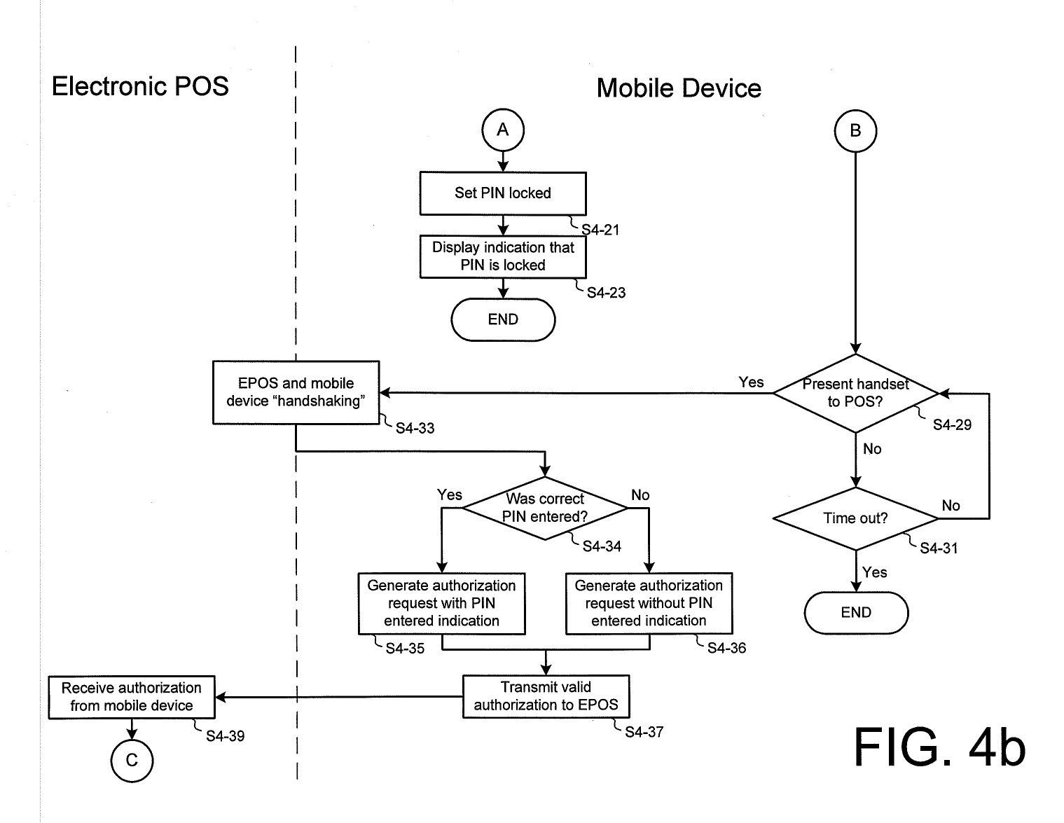

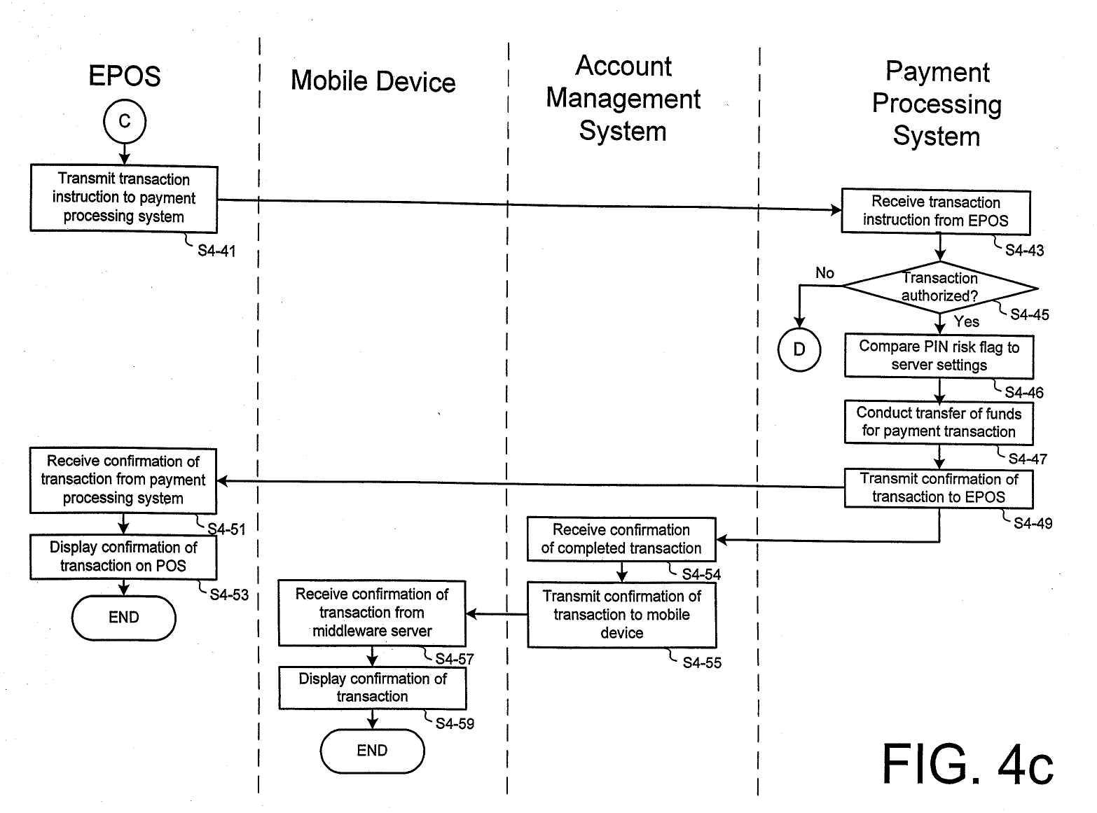

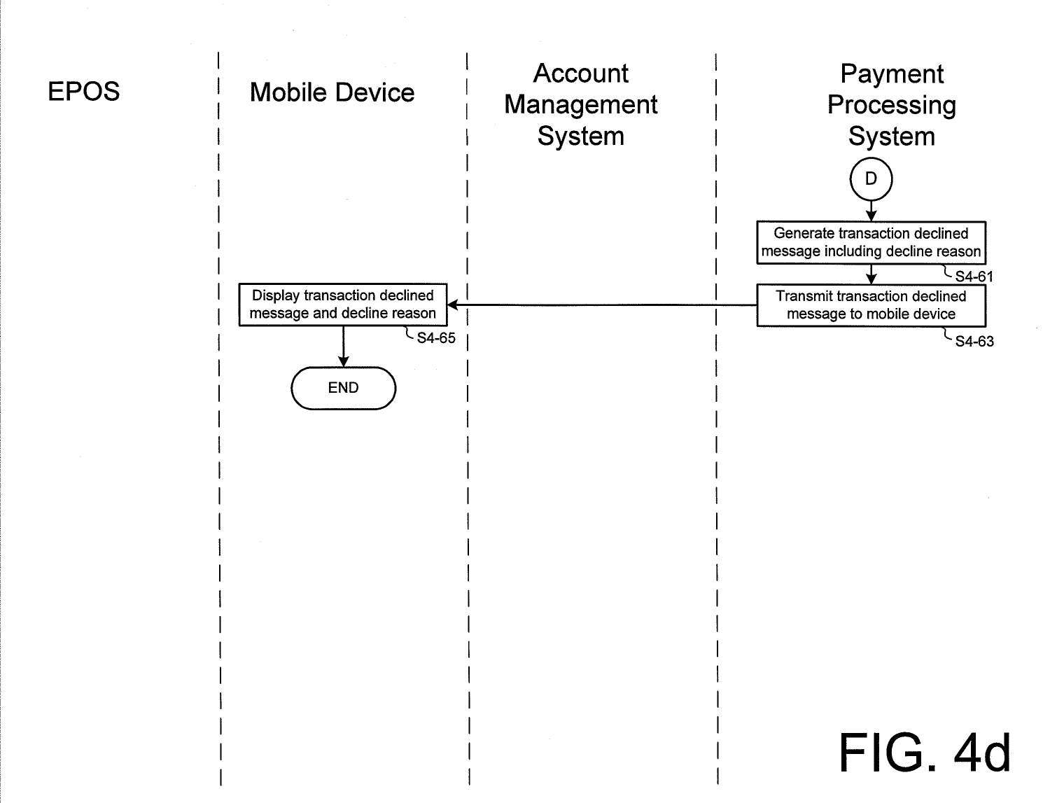

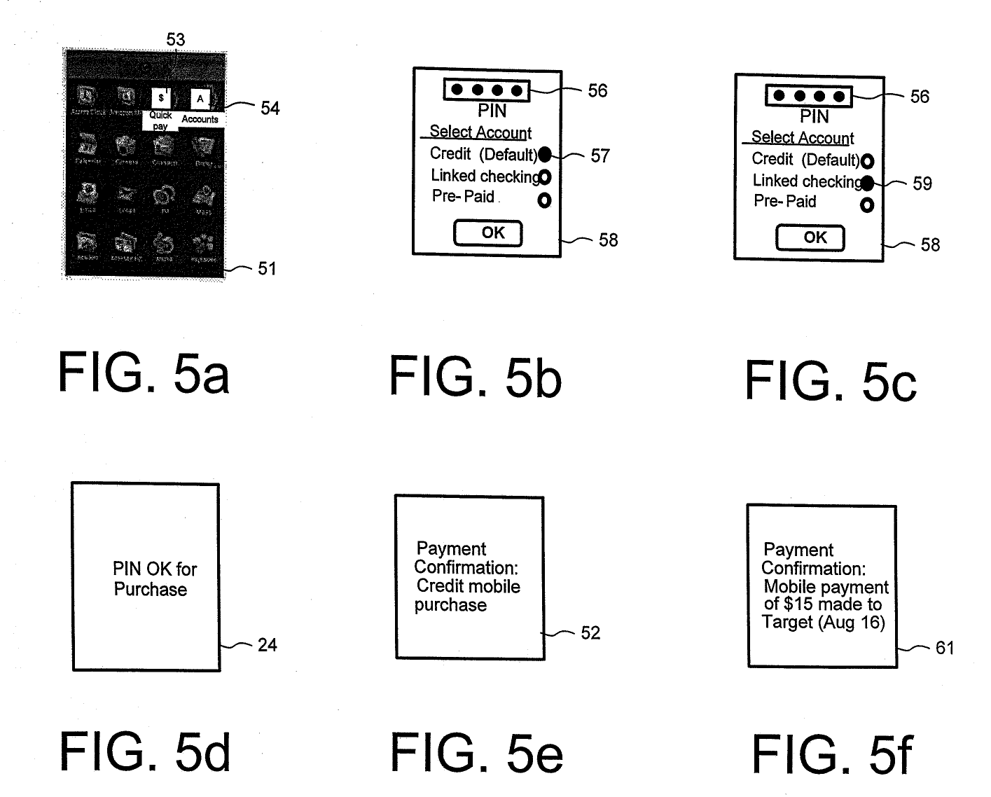

A brief description has been given above of the components forming part of the mobile payment system 1. A more detailed description of the operation of these components according to a first embodiment will now be given with reference to the flow diagrams of FIGS. 3 and 4. FIGS. 3 and 4 describe a computer-implemented process for a mobile payment transaction using the mobile device 3 configured with one or more activated mobile payment accounts. Reference is also made to FIG. 5, which comprises FIGS. 5a to 5f, schematically illustrating exemplary display screens that are presented to the user on the mobile device 3 in a payment transaction process.

As shown in FIG. 3, the process begins at step S3-1 where the mobile device 3 receives a user input to unlock the mobile device 3, if the mobile device 3 is in a locked state. At step S3-3, the mobile device 3 receives a user input selection of an application icon 53 for the wallet application payment shortcut module 19, instead of the application icon 54 for the fully featured wallet application module 8. The user selection can be input, for example, via the mobile device touch sensitive display screen, that is, the keypad 23 of the user interface 22. FIG. 5a illustrates an exemplary display 51 of user selectable icons for the various applications stored on the mobile handset and many other known arrangements will be apparent depending on the operating system and hardware of the mobile device 3. In response to receiving the user input selection, the mobile device 3 launches the shortcut application and executes the processing instructions. In an embodiment, the processing instructions define a link to the processing instructions of the transaction authorization sub-module. In this way, at step S3-7, the user is directly presented with a wallet screen 55 for facilitating activation of the payment feature from the electronic wallet on the mobile handset, without having to navigate through menus and options of the main wallet application module 8 in order to find the activation wallet screen. Once the payment feature of a selected mobile payment account has been activated on the mobile device 3, the mobile device 3 can be used to conduct a payment transaction with the merchant electronic POS terminal 5 via the contactless communication link 9. In response to the user waving the mobile device 3 past a contactless communication interface of the POS terminal 5, the mobile device 3 effects a payment transaction from the selected mobile payment account and outputs confirmation of the payment transaction once completed at step S3-9.

FIG. 4, which comprises FIGS. 4a to 4d, illustrates the main processing steps performed by the main components of the mobile payment system 1 in the above steps S3-7 and S3-9 illustrated in FIG. 3. As shown in FIG. 4, processing user inputs to activate the payment feature on the mobile handset starts at step S4-1 with the wallet application module 8 calling the authentication applet instance 46 to check a PIN entry mode as set by the user. In this embodiment, the customer is able to make “tap and go” purchases for low dollar transactions. However, customers can elect to have a PIN set for all transactions. Therefore, a PIN mode is required for detecting this preference. The user selected configuration for the use of PIN, for example via the wallet application module 8, supports two PIN modes. The two PIN modes are:
an “Always Required” mode, which results in no valid authorization request being transmitted from the mobile device 3 if a PIN is not entered (in this mode, the user will be required to successfully verify their PIN in order to process a valid transaction, regardless of whether the transaction value is high or low); and
an “Only As Necessary” mode, which results in an authorization request that has indication of successful user PIN entry being generated and transmitted by the mobile device 3, and authorization decisioning can then be performed at the middleware server 16 based on other factors such as a transaction risk level (i.e. taking into consideration if the value of the payment transaction is above a threshold value, such as $50).

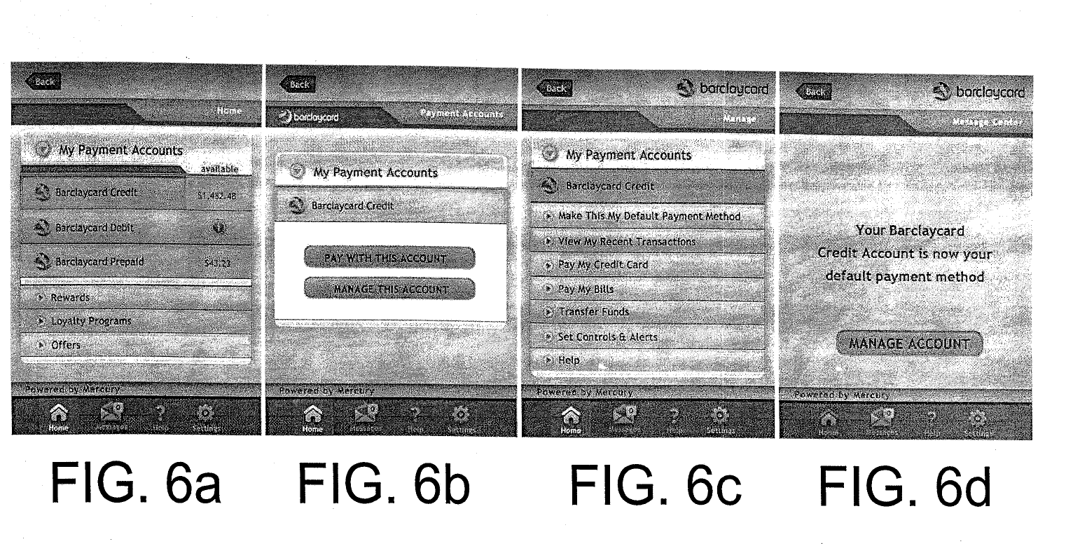

If the mobile device 3 determines that the PIN mode is set to “Always Required” mode at step S4-1, then at step S4-3, the mobile device 3 prompts the user for entry of a PIN. As schematically illustrated in FIG. 5b, the mobile device 3 displays a wallet screen 55 which includes a prompt and a password field 56 for the user to enter a PIN and also includes a prompt for the user to change a selected one of the mobile payment accounts stored in the mobile device 3 as described above. The mobile payment wallet application module 8 provides separate wallet screens 24 for facilitating user setting of a particular mobile payment account that is to be displayed as a selected payment account by default, as indicated by a selected account indication 57 for the default account. FIG. 5c shows an exemplary wallet screen 58 displaying a different selected account indication 59 after the user has selected a different mobile payment account 59 for conducting the subsequent payment transaction. User configuration of the default selected mobile payment account is facilitated by wallet screens 24 accessible from the main menu wallet screen 26 for accessing and changing mobile payment account details. FIGS. 6a to 6d show an exemplary sequence of wallet screens for accessing details for a credit account linked with the mobile payment account, and for setting the credit account as the default payment method so that the credit account is displayed as the selected payment account by default.

At step S4-5, the mobile device 3 checks if user input of an entered PIN has been received via the wallet screen 55. The entered PIN in the password field 56 can be masked on the displayed screen with hidden characters as the user inputs each character or number. Additionally, the user's sensitive mobile payment account details, such as card numbers, expiration dates and CVV codes, are encoded in the wallet application module 8 and never displayed on-screen, thereby further reducing the risk of fraud. If the mobile device 3 determines at step S4-5 that no PIN has been entered, then at step S4-7, the mobile device 3 checks if the mobile device has been waved past the contactless communication link interface of a POS terminal 5 and if not, processing returns to step S4-3 for the user to enter a PIN. As those skilled in the art will appreciate, when the mobile device 3 and POS terminal 5 are within range, one of the contactless communication link interfaces will initiate communication, referred to herein as “device handshaking”, to establish the contactless communication link, illustrated as step S4-9. It is commonly known that such contactless communication link interfaces generally communicate under the guidelines of ISO 14443, whereby the reader at the POS terminal 5 emits a signal that is received and interpreted by the contactless link interface 37 in the mobile device 3.

In this case, the user has not entered a PIN although the mobile device 3 is expecting a PIN and has proceeded to present the mobile device 3 to the POS terminal 5 at step S4-7. This may be because the user has simply forgotten to input a PIN and therefore the mobile device 3 is configured to not perform any interaction between the mobile device 3 and the POS terminal 5 without a user entered PIN. Consequently at step S4-11, the POS terminal 5 does not react to the presence of the mobile device 3 because no appropriate data or request has been transmitted. Alternatively, the POS terminal 5 can be adapted to generate and output an error code so that, for example, a store clerk can see the displayed error and communicate to the customer that PIN entry is required to complete the transaction. As a further alternative, the mobile device 3 can be adapted to display a message to the user indicating the need to enter a PIN in order to activate the payment feature. Processing then returns to step S4-3 where the user is again prompted to enter a PIN.

On the other hand, if the mobile device 3 determines at step S4-5 that a PIN has been entered, then at step S4-13, the mobile device 3 sets the PIN entry flag 101 and verifies if the user input PIN is valid by comparing the input PIN with the user's defined PIN 100 stored in the wallet application secure data 6. If the mobile device 3 determines at step S4-13 that the user input PIN is not correct, then at step S4-17, the wallet application module 8 updates a count of the number of incorrect PIN entry attempts. It is appreciated that the wallet application module 8 can be configured to check, at step S4-19, if a PIN is successively entered incorrectly a defined number of times and if so, to lock the PIN at step S4-21 and to display an indication that the PIN is locked at step S4-23. Locking of the PIN effectively prohibits the payment feature for the mobile payment account until the user has unlocked the PIN for example via a PIN reset process as will be apparent to those skilled in the art. On the other hand, if the PIN has not been successively entered incorrectly a defined number of times, then processing returns to step S4-3 where the user is prompted to re-enter a correct PIN.

When the mobile device 3 determines at step S4-13 that a correct PIN has been entered, then at step S4-25 the authentication applet 46 resets the PIN risk flag 103. At step S4-27, the authentication applet 46 sets the PIN-verified flag 109 that will be used when generating the next transaction authorization request as described below. In an embodiment, the mobile device 3 is arranged to display a wallet screen 24, for example as schematically illustrated in FIG. 5d, to confirm that a verified PIN was entered and to indicate to the user that the selected mobile payment account is now enabled to conduct a payment transaction.

At step S4-29, the mobile device 3 then checks if the contactless link interface 37 has been placed within range of a contactless communication link interface of a POS terminal 5. In an embodiment, the mobile device 3 is configured to only allow a mobile payment transaction to be conducted using the selected mobile payment account within a predefined time window from the time when the correct PIN has been entered by the user. Therefore, at step S4-31, the mobile device 3 checks if a predefined time has elapsed since the correct PIN has been entered by the user, and to terminate the process if the mobile device 3 is not presented to a POS terminal 5 in time. It is appreciated that such a time out can reset the PIN entered and PIN verified flags.

As discussed above, at step S4-33, when the mobile device 3 and POS terminal 5 are within range, the respective contactless communication link interfaces will initiate communication, typically in the form of device handshaking to establish the contactless communication link. In response, the wallet application module 8 checks, at step S4-34, if a correct PIN was entered by the user in step S4-13 above as necessary. The wallet application module 8 can check if the PIN entry flag 101 and PIN verified flag 109 are set. If a correct PIN was entered by the user, then at step S4-35, the mobile device 3 generates an authorization request including a data value indicating that the correct PIN was entered. Otherwise, at step S4-36, the mobile device 3 generates an authorization request where the data value indicates that no correct PIN was entered. As is commonly known, this indication can be provided as a unique transaction identifier of a verified PIN according to the specific contactless chip and/or card technology in use (for example the known dCVV or CVC3 identifiers). At step S4-37, the mobile device 3 transmits the valid authorization message to the electronic POS terminal 5 to authorize that the payment transaction be effected from the associated payment account issuer 10 to the merchant bank 12. The user entered PIN is therefore never transmitted by the mobile device 3 thereby further reducing risk of fraud.

The above procedure described the processing steps for the “Always Required” PIN mode. If at step S4-1, the mobile device 3 determines that the PIN mode is set to the “Only As Necessary” mode, then step S4-4, the mobile device 3 checks if the PIN Risk flag 103 is set, thus requiring input of a passcode before a payment transaction can be authorized. If the PIN Risk flag 103 is set, then processing proceeds to step S4-3 as discussed above. However, if the PIN Risk flag 103 is not set, then processing proceeds directly to step S4-27 where the PIN verified flag 109 is set and the payment feature is activated without requiring user input of a PIN or passcode.

Thereafter, the POS terminal 5 instructs a payment transaction from the user selected mobile payment account to the merchant bank. At step S4-39, the POS terminal 5 receives the authorization request from the mobile device 3 and at step S4-41 transmits a transaction instruction, via the payment association network 17, to the payment processing system 10a of the payment account issuer 10 associated with the user selected mobile payment account. At step S4-43, the payment processing system 10a receives the transaction instruction from the POS terminal 5 and in response, performs authorization decisioning for the instructed transaction at step S4-45. Authorization decisioning can be based on any number of factors, primarily checking that the available balance of the associated user payment account is sufficient to cover the payment transaction, and then checking if the PIN verified flag is set based on a transaction risk level (for example if the value of the transaction is above a predefined threshold value), and/or checking if the PIN was previously entered incorrectly, etc. Other factors related to internal account status, such as usage thresholds, existing restrictive status, unusual purchase patterns and/or suspicious transactions identified by predefined rules or conditions, can also be considered by the payment processing system 10a when determining if a requested transaction is to be authorized. Optionally, the payment processing system 10a can also consider whether the PIN risk flag 103 is set on the mobile device 3 by comparing the PIN risk flag value to server settings at step S4-46.

When the payment processing system 10a determines that the payment transaction is authorized, the transfer of funds from the account associated with the selected mobile payment account is effected at step S4-47, and confirmation of the transaction is transmitted to the POS terminal 5 at step S4-49. At step S4-51, the POS terminal 5 receives confirmation of the completed transaction from the middleware server 16 and at step S4-53, the POS terminal 5 outputs the confirmation to the merchant.

At step S4-54, the middleware server 16 of the account management system 7 receives confirmation of the completed transaction from the payment processing system, that is, the payment account issuer, 10. In response, at step S4-55, the account management system 7 optionally transmits confirmation of the completed transaction to the mobile device 3 via the cellular telephone network 11, for example. At step S4-57 the mobile device 3 receives the payment transaction confirmation from the account management system 7 and outputs, at step S4-59, confirmation of the payment transaction via a wallet screen 52 as schematically illustrated in FIG. 5e. The mobile device 3 can also be configured to output an audible confirmation of the payment.

On the other hand, the payment processing system 10a can determine at step S4-45 that the payment transaction is to be declined due to a PIN related reason, such as an incorrect entered PIN or the absence of PIN entry. If the payment transaction is declined, then in response at step S4-61, the payment processing system 10a generates a transaction declined response message including information identifying the reason for the declined transaction. The transaction declined response message is transmitted to the mobile device 3 at step S4-63 and displayed by the mobile payment wallet application module 8 at step S4-65.

In the embodiment described above, the authorization request generated by the mobile device 3 at step S4-35 or step S4-36 included a binary data value indicating whether or not a correct PIN was entered to the mobile device 3. In an alternative embodiment, the mobile device 3 is adapted to generate an authorization request including a multi-faceted value instead of a binary data value relating to PIN entry through the mobile payment wallet application module 8 of the mobile device 3. The multi-faceted value can be used to identify one of more than two states of a user's PIN-related actions, for example:
1. A PIN was entered to the mobile payment wallet application module 8 and was verified as a correct PIN matching the pre-defined PIN stored in the wallet application secure data 6.
2. A PIN was entered to the mobile payment wallet application module 8 but was not verified as a correct PIN because the entered PIN did not match the pre-defined PIN stored in the wallet application secure data 6.
3. A PIN was not entered in the mobile payment wallet application module 8 because the PIN mode was set to “Only as necessary”.

In this alternative embodiment, the payment processing system 10a receives the authorization request including a multi-faceted value and can determine whether or not to authorize the payment transaction based solely on the received multi-faceted value or in combination with other transmitted values in the authorization request and/or locally stored values, as discussed above at step S4-45. When it is determined at step S4-45 that the payment transaction is to be declined due to a PIN related reason, then the payment processing system 10a generates a transaction declined response message including information identifying the specific cause of the PIN related reason for the declined transaction, for example that a PIN was not entered at all or that a PIN was entered but the entered PIN did not match the stored PIN. Advantageously, the user is thereby alerted that the requested transaction was not authorized and is given an explanation of the cause or reason for the decline.

In a further alternative embodiment, the user selected mobile payment account can be linked to a checking account at a payment account issuer 10. The authorized account details transmitted to the POS terminal 5 via the contactless communication link 9 identifies the payment account as a checking account. Typically, the POS terminal 5 will then request additional input from the user before the payment transaction can be completed by the POS terminal 5. For example, the additional input may be in the form of a prompt to select a specific payment type such as credit or debit, and the user may be required to input a signature via a touch sensitive input screen of the POS terminal 5.

In another alternative embodiment, the middleware server 16 can be additionally configured to receive details of the payment transaction, from the payment account issuer 10 after the payment has been transferred or from the merchant POS terminal 5 or merchant bank 12 directly. In response, the middleware server 16 can be further arranged to communicate additional confirmation of the payment to the mobile device 3, including details of the amount of funds that was transferred, the name of the target recipient, and the date of the payment transaction. The additional payment confirmation can be displayed by the mobile device 3 as a further payment confirmation wallet screen 61 as schematically illustrated in FIG. 5f.

### Remote PIN Management

In an embodiment of the present invention, the payment processing (authorization and fraud monitoring) system 10a is additionally configured to offer additional tools to remotely set the PIN risk flag 103 stored securely on the mobile device 3 to force a challenge the next time the mobile device 3 is used to make a transaction attempt as described above. With the PIN risk flag 103 set on the mobile device 3, the customer will always be asked to enter their passcode/PIN before another transaction, regardless of transaction amount, can be made on the mobile device 3 in the manner described above. Once the passcode is entered on the mobile device 3, the PIN risk flag 103 is unset on the secure element 4 to allow a transaction to the point of sale. Without the PIN risk flag 103, a thief may steal a mobile device 3, for example, a cellular phone, and would be able to use that phone indefinitely for multiple low dollar transactions without ever being prompted for a PIN. With the facility to remotely set the PIN risk flag 103, the payment processing system 10a could be additionally configured with a set threshold of usage or to react to unusual purchase patterns or based upon a number of low dollar transactions since the PIN was entered last. Such an implementation can beneficially be used to efficiently monitor low dollar transactions. As is commonly known, such low dollar transactions are typically the payment issuer's liability and are not generally able to be charged back to the retailer. As discussed above, the information that a verified passcode or PIN entry has been made would be sent with the next transaction to inform the merchant and payment issuer systems that the customer has verified themselves. Even small dollar transactions could be blocked at the issuing bank until the customer verified themselves.

In order to set the risk flag remotely, the payment processing system 10a is configured to detect unusual usage based upon a variety of predefined risk factors. The risk factors detect unusual behavior from a customer and can include a combination of attributes such as unusual merchant locations for the customer, time of day differences from normal usage patterns, a higher velocity of transaction attempts, or other proprietary models. Current issuing bank processes can shut off the payment capability of a payment account until the user verifies possession of the payment account to the bank, but this new process allows for a gentler interaction between the customer and the bank. The present embodiment advantageously allows for the customer to verify themselves in the act of payment when the customer wishes to make their next payment. This further reduces the number of bank resources required to contact customers and manage the fraud flags on accounts.

Current plastic card based contactless technologies can only be updated when in contact with a chip card reader. Some payment association specifications allow for account updates to contactless cards via these chip card readers, but these are rarely used since these payment accounts are typically waved over a reader versus inserted into a dedicated chip card reader. Adding the payment account to a mobile device allows for additional data fields to be sent over the air to the mobile device to effect payments.

A summary of the remotely set risk flag process in mobile device enabled payment transactions will now be provided.

In this embodiment, the process would detect the anomaly using current payment authorization processes and then communicate the new risk flag value to the mobile device 3 over the air via a Trusted Service Manager (TSM) and cellular communication networks. The updated risk flag value would be stored into the secure element 4 of the mobile device 3 where the PIN risk flag 103 resides, in control of the payment account issuer 10. This PIN risk flag 103 updating process can start with an issuing bank fraud detection system deciding the payment account is not to be trusted without further customer verification. The fraud detection system can elect to prevent any new transactions until the PIN risk flag 103 has been cleared. The bank fraud detection system would then send a message to the bank's payment processing system 10a with the specific customer account information and risk flag setting. In many cases, the issuing bank will have a TSM of their own that will broker communication to a mobile network operator's TSM which will talk to the phone. The bank's payment processing system 10a would communicate with the issuing bank TSM to logically and physically prepare the new risk flag data commands for the targeted mobile device 3. The issuing bank TSM communicates with the mobile network operator TSM to deliver the new PIN risk flag 103 to the mobile device 3. It will be appreciated that alternatively or additionally, the mobile device 3 can be configured for direct communication with the issuing bank TSM, for example to receive settings and information from the payment processing system 10a via push and/or Short Message Service (SMS) technology. Once received by the mobile device 3, the new risk flag setting will be stored into the secure element 4 for use in the next transaction as described above with reference to FIG. 4.

As described above, on the mobile device 3, the transaction process can vary based upon user provided settings to either require a passcode prior to any transaction attempt, or provide a passcode only for high value transactions—for example any transactions above a threshold value between $25 and $50 based upon the issuing bank and payment association rules. Payments from mobile devices 3 as described above generally follow a process as follows. The mobile device is held near a point of sale (POS) reader. The reader emits a signal received and interpreted by the contactless link interface in the mobile device. The contactless reader interface is a near field communication (NFC) process generally communicating under the guidelines of ISO 14443 and further refined by payment association specifications for specifying the message values between the contactless reader interface of the POS terminal 5 and mobile device 3.

The contactless reader interface identifies the point of sale communication is a payment request. As configured in the mobile device 3, the PPSE application 41 is called to provide a payment account instance within the secure element 4 processor subsystem. The PPSE application 41 determines the payment account currently selected for use on the mobile device 3 and hands control to a payment association specific instantiation 40 of a payment application that ultimately provides the account information.

The payment application 40 within the secure element 4 of the mobile device 3 will determine if the passcode was required, entered and then pass that information along with the payment account information for use in the transaction. The payment application 40 can also access other data values stored within the secure element 4 such as the PIN risk flag 103. The payment application 40 can also use local values to determine if the user preference for the passcode needing to be verified or other counters for allowing only so many transactions before a passcode to be entered. The remote setting of the PIN risk flag 103 is one opportunity for issuing banks to allow multiple small dollar transactions within normal customer transaction operations and ask only for the passcode in case of unusual customer activity.

If the PIN risk flag 103 is set to a value requiring user input, the payment application 40 returns an error value to the contactless reader interface as well as messaging to the mobile device to alerting the user that a passcode is required before a transaction can be made. Other reasons for passcode required entry are if the user has set their preference to always require passcode entry for any transaction. Otherwise, the payment application will allow the transaction.

If the payment application 40 allows the transaction to proceed, the specific payment account data is passed back to the POS terminal 5. The POS terminal 5 interprets the message and assembles the payment account data for a transaction request to the association payment network. The message is routed through the payment network to the payment account issuer 10.

The transaction request is received at the payment account issuer 10 and processed for approval based upon funds availability as well as fraud decision strategies. The setting of the value of the risk flag is kept at the issuer systems and the current value of the passcode verification is sent with each mobile transaction request to the payment account issuer 10 over the payment network authorization message. Among all other rules determining transaction success at the issuer's payment authorization system, the transaction will be denied if the passcode is not verified and the risk flag is set to a value on the mobile device. Additional risk and fraud strategies can be employed by the payment account issuer 10 to determine if this transaction will be allowed as per normal business processes.

If the PIN risk flag 103 is set at the time of transaction attempt, and the passcode has been entered—passed in via the transaction request, this action will clear then the payment processing system 10a flags that the fraud check has been passed. This action will restart any low dollar risk checks for unusual usage and the PIN risk flag 103 can be set again at some future point of time.

The remote setting of a PIN risk flag 103 therefore allows customers to make a number of low dollar transactions without ever having to enter a passcode if the bank system sees the activity as normal use. The customer will not be forced to enter a passcode every set number of low dollar transactions if the bank feels the risk is low.

An addition to this process could be a remote setting of the number of low dollar transactions to be used before the next passcode verification is required. If a local counter mechanism for passcode verification is employed on the mobile device 3, the counter could be set remotely by the payment account issuer 10 via the same TSM process described above. This could allow a flexible counter to be increased over time as usage patterns are determined by the issuing bank and customer habits are formed. Upon successful entry of the passcode, the counter is reset to the value.

### Advantages

A number of advantages will be understood from the above description of the embodiments of the present invention.

In particular, the remote setting of a risk flag can prevent monetary loss by the issuing bank for low dollar transactions made by a perpetrator.

The solution allows the customer to easily self correct any possession activity verification without requiring an outbound contact from the issuing bank. The customer simply enters their passcode prior to making their next transaction.

The issuing bank can set the risk flag ahead of any transaction attempt by the customer at a merchant. The merchant checkout does not have to communicate a declined transaction attempt to the customer. If the merchant were an unattended vending machine, this error could cause customer confusion and frustration. The customer is able to correct their risk setting locally as part of the transaction flow.

The transaction information process flow with merchant point of sale systems is unchanged requiring no additional work by a merchant.

The embodiments allow the bank to decide when a customer requires authentication of the payment account based upon flexible risk criteria.

The embodiments provide for alerts to the user that a requested transaction was not authorized for a passcode entry related reason, where a multi-faceted value in the transaction request enables the payment processing server to provide an explanation of the cause or reason for the decline.

The embodiments also allow for remote management of local passcode verification counters to allow the bank to automatically ask for passcode verification after a configurable number of low dollar transactions.

### Alternative Embodiments

It will be understood that embodiments of the present invention are described herein by way of example only, and that various changes and modifications may be made without departing from the scope of the invention.

For example, in the embodiments described above, the mobile device includes a communication interface for facilitating communications over a respective type of contactless communication link. As an alternative, the mobile device may include a plurality of communication interfaces for enabling the plurality of transaction applets to carry out contactless communications over a plurality of respective types of contactless communication links. In this way, the mobile device would be capable of conducting contactless transactions over a combination of contactless communication links such as near field communication (NFC), infra-red and/or optical (eg. for bar code scanning), ultra-sonic, radio frequency (eg. RFID), wireless such as Bluetooth or Wi-Fi based on the IEEE 802.11 standards, and any other communication link that does not require direct physical contact.

As a further embodiment, the mobile device may be additionally or alternatively configured for conducting mobile transaction operations over any other form of communication link that requires a contact and/or coupling of communication interfaces. In this case, the mobile device may include a plurality of transaction modules operable to process mobile transaction operations with a respective transaction account over a communication link via an associated communication interface of the mobile device. Preferably but not essentially, at least one of the transaction modules is configured for contactless transaction operations over at least one type of contactless communication link.

In the embodiments described above, the mobile payment account is provisioned on a mobile handset which communicates with the account management system via a cellular telephone network. Instead of a mobile handset, other portable electronic devices configured for contactless payment with a merchant electronic POS, and having suitable input and display means, may carry out the functionality of authenticating a transaction using a central authentication module, as described in the above embodiment. Additionally, the portable electronic device is configured to communicate with the account activation system via any other form of communication channel instead of or in addition to the above discussed over the air channels, such as a wired or wireless network connection, a Bluetooth connection, or the like. Alternatively, the mobile payment account data is provisioned on the portable electronic device by data transfer via any suitable data communication path or by way of a computer readable medium.

In the embodiments described above, the mobile device is provisioned with a mobile payment account through secure transfer of data representing the mobile payment account, which data including data defining an amount of pre-paid funds transferred from the user's payment account issuer and/or data identifying a user's account at a payment account issuer from which funds can be transferred to a merchant bank to complete a transaction. It is appreciated that the mobile device may instead or additionally be securely provisioned with data representing one or more other types of accounts, such as an insurance account, a loyalty and rewards scheme membership or the like, and the account activation system may be configured to conduct a secure data transfer to the mobile device of data representing such an account, for example including the account or membership number or any other type of secure reference number.

In the embodiments described above, the wallet application secure data stores a plurality of flags that are accessed and maintained by the payment and authentication applets. It is appreciated that the flags are data values indicative of one of a plurality of predefined states of an associated variable. In the embodiments described above, separate flags are provided for the plurality of variables, each flag having a true or false state. Many alternative forms of representing the flags and variable states will be apparent to the skilled person.

In the embodiments described above, the mobile device includes a user configured “PIN mode”, one of “Always Required” and “Only As Necessary”. As an alternative to the user setting whether or not a PIN is required, the POS can be configured to transmit a low transaction value indication to the mobile device, based on a predefined threshold for the transaction value. For example, a POS terminal of a vending machine can be configured to always transmit a low transaction value indication with any payment request message if all of the items in the vending machines are known to be under a predefined threshold value. In such an alternative, the mobile device would be configured to determine if PIN entry is required based on the received low transaction value indication. For example, the mobile device can be configured to require PIN entry if the message received from the POS terminal indicates that the transaction involves a high transaction value.

In the embodiments described above, the mobile device stores a plurality of application modules (also referred to as computer programs or software) in memory, which when executed, enable the mobile device to implement embodiments of the present invention as discussed herein. It is appreciated that the software may be stored in a computer program product and loaded into the mobile device using any known instrument, such as removable storage disk or drive, hard disk drive, or communication interface, to provide some examples.

In the embodiments described above, the account management system is described as a separate entity to the payment account issuer and the associated payment processing system. It is appreciated that the account management system may be provided as an integral part or sub-system of the payment account issuer and/or payment processing system.

In the embodiments described above, the passcodes are personal identification numbers (PINs). Alternatively or additionally, the wallet application could use any other form of passcode such as an alphanumeric passcode, a numeric passcode of varying length, gesture based actions, or facial recognition.

Alternative embodiments may be envisaged, which nevertheless fall within the scope of the following claims.

1. A method of conducting a contactless payment from an electronic wallet on a mobile device, comprising:
storing, on the mobile device, an electronic wallet comprising data for authorizing a payment transaction, wherein the data includes a passcode for enabling access to the electronic wallet;
generating, by the mobile device, a transaction request message including a value identifying one of a plurality of passcode entry related states; and
transmitting, by the mobile device, the generated transaction request message to a remote apparatus.

2. The method of claim 1, wherein the plurality of passcode entry related states include:
1) a first state indicative that a passcode was received and verified by the mobile device;
2) a second state indicative that a passcode was received and identified by the mobile device as an incorrect passcode; and
3) a third state indicative that a passcode was not received by the mobile device.

3. The method of claim 1, further comprising determining, by the remote apparatus, that the transaction request message is declined based at least on the value received identifying a passcode entry related state.

4. The method of claim 3, wherein responsive to determining that the transaction request message is declined for a passcode related reason, the remote apparatus transmits a transaction decline response to the mobile device identifying the passcode related reason for decline.

5. The method of claim 4, wherein the transaction decline response comprises a value representing that a passcode was not entered at all or that an incorrect passcode was entered.

6. The method of claim 5, further comprising displaying, by the mobile device, a transaction declined response including the received passcode related reason for decline.

7. The method of claim 3, wherein the remote apparatus determines that the transaction request message is declined based additionally on a threshold of usage of the electronic wallet.

8. The method of claim 3, wherein the remote apparatus determines that the transaction request message is declined based additionally on an unusual purchase pattern from the electronic wallet.

9. The method of claim 1, wherein the remote apparatus is a server associated with a payment account issuer.

10. The method of claim 1, wherein the data of the electronic wallet is stored in a secure element of the mobile device.

11. The method of claim 1, wherein the passcode comprises numeric, alphabetic, alphanumeric or non-alphanumeric symbols.

12. The method of claim 1, wherein the generated transaction request message is transmitted via a contactless communication link comprising at least one of near field communication (NFC), infra-red, optical, ultra-sonic, radio frequency, wireless and Bluetooth.

13. A mobile device for conducting contactless payment from an electronic wallet on the mobile device, comprising:
a memory storing an electronic wallet comprising data for authorizing a payment transaction, wherein the data includes a passcode for enabling access to the electronic wallet;
an application module operable to generate a transaction request message including a value identifying one of a plurality of passcode entry related states; and
a transmitter operable to transmit the generated transaction request message to a remote apparatus.

14. The mobile device of claim 13, further comprising a receiver operable to receive a transaction decline response identifying a passcode related reason for decline from the remote apparatus in response to a determination by the remote apparatus that the transaction request message is declined based at least on the value received identifying a passcode entry related state.

15. A computer program stored on a non-transitory computer-readable medium comprising program code for conducting a contactless payment from an electronic wallet on a mobile device when executed by the mobile device, comprising:
computer-implementable instructions for storing an electronic wallet comprising data for authorizing a payment transaction, wherein the data includes a passcode for enabling access to the electronic wallet;
computer-implementable instructions for generating a transaction request message including a value identifying one of a plurality of passcode entry related states; and
computer-implementable instructions for transmitting the generated transaction request message to a remote apparatus.
